(19) United States
(12) Patent Application Publication
(10) Pub. No.: US 2007/0225858 A1
(43) Pub. Date: Sep. 27, 2007

(54) CONTROL SYSTEM FOR A PALLET LOAD TRANSPORT SYSTEM

(75) Inventors: Michael D. Martin, Floyds Knobs, IN (US); Frank M. Lauyans, Louisville, KY (US)

Correspondence Address: STITES & HARBISON, PLLC, 400 W MARKET ST, SUITE 1800, LOUISVILLE, KY, 40202-3352, US

(73) Assignee: LAUYANS & COMPANY, Louisville, KY (US)

(21) Appl. No.: 11/688,911

(22) Filed: Mar. 21, 2007

Related U.S. Application Data
(60) Provisional application No. 60/743,744, filed on Mar. 24, 2006.

(51) Int. Cl. G06F 7/00

(52) U.S. Cl. 700/213

(57) ABSTRACT

A pallet load transport system includes a shuttle car that is supported by and moves along a track between a pick-up location to a deposit location. A control system monitors and controls all operation of the shuttle car, ensuring proper and safe transfer of pallet loads from the pick-up location to the deposit location. Signal from various measuring devices and/or sensors are input into a programmable logic controller. Based on the application of a control logic to the received signals, output signals are generated and sent to a variable frequency drive, which controls the linear movement of the shuttle car along the track through operation of a motor mounted on the shuttle car.

### CROSS-REFERENCE TO RELATED APPLICATIONS

This application claims priority to U.S. Provisional Patent Application No. 60/743,744, filed Mar. 24, 2006, the entire disclosure of which is incorporated herein by reference.

### BACKGROUND OF THE INVENTION

The present invention relates to material handling systems and technology, and, more particularly, to a control system for a pallet load transport system that moves pallet loads from a pick-up location to a deposit location.

In one common application of such a pallet load transport system, a pallet load is picked up from a mainline conveyor and deposited at an automatic storage and retrieval (ASRS) crane interface station. Alternatively, a pallet load may be picked up at the crane interface station and deposited onto the mainline conveyor. In any event, the pallet load system includes a shuttle car that moves between the mainline conveyor and the crane interface station to transport the pallet load.

In pallet load transport systems of the prior art, there is a pick-up and delivery (P&D) shuttle car that transports a pallet load between a mainline conveyor and a crane interface station. Specifically, the shuttle car is supported by and moves along a track between the mainline conveyor and the crane interface station. The shuttle car itself is generally comprised of a lower carriage and an upper carriage (or lift assembly), and the upper carriage can be raised or lowered relative to the lower carriage. Accordingly, as the shuttle car carries a pallet load between the mainline conveyor and the crane interface station, the upper carriage is commonly in a raised position relative to the lower carriage, but as the shuttle car approaches the mainline conveyor or the crane interface station, it is in a lowered position to pick-up or deposit a pallet load. However, there are many problems with such pallet load transport systems.

For example, Applicant is unaware of any prior art constructions that include any controls on the shuttle car that would allow for monitoring of whether the upper carriage was in a raised or lowered positioned relative to the lower carriage. If, due to some mechanical malfunction, the upper carriage was in the wrong position when picking up or depositing a load, the pallet load could be pushed off of the shuttle car.

For another example, Applicant is unaware of any prior art constructions that include any controls on the shuttle car that would allow for monitoring of whether the pallet load to be carried by the shuttle car was actually on the shuttle car. Accordingly, a pallet load could fall off of the shuttle car, but the shuttle car would continue operating.

For yet another example, Applicant is unaware of any prior art constructions that provide for monitoring of position, speed, and direction of travel of the shuttle car. In this regard, the drive for the shuttle car in prior art constructions was located at one end of the track, i.e., near the mainline conveyor or the crane interface station. The drive (commonly a two-speed drive) is operably connected to the shuttle car by a chain for effectuating travel of the shuttle car along the track. Because of the length of the chain, which would extend from one end of the track, around the drive and back to that end, the chain tends to gradually stretch, which could cause a malfunction with the shuttle car.

Accordingly, there remains a need in the art for a control system for a pallet load transport system that would address the above and other such deficiencies in prior art constructions.

### SUMMARY OF THE INVENTION

The present invention is a control system for a pallet load transport system.

The pallet load transport system includes a shuttle car that is supported by and moves along a track between a mainline conveyor and a crane interface station. The shuttle car is generally comprised of a lower carriage and an upper carriage, and the upper carriage is adapted for movement between a raised and a lowered position relative to the lower carriage. For inbound transport, the shuttle car will pick-up a pallet load from the mainline conveyor and deposit it at the crane interface station. For outbound transport, the shuttle car will pick-up a pallet load from the crane interface station and deposit at the mainline conveyor.

The control system of the present invention monitors and controls all operation of the shuttle car, ensuring proper and safe transfer of pallet loads from the pick-up location to a deposit location. Specifically, an encoder or similar measuring device is installed on the shuttle car and is used to determine the linear position of the shuttle car along the track. Additionally, proximity or limit switches are installed on the shuttle car with targets near the mainline conveyor and the crane interface station in order to detect any over travel of the shuttle car. With respect to the raising and lowering of the shuttle car, a proximity or limit switch is also installed on the shuttle car and is used to determine whether the upper carriage is in the raised or lowered position with respect to the lower carriage. To determine the presence of a pallet load on the shuttle car, two photoelectric eyes or similar sensors are also installed on the shuttle car. Finally, a photoelectric eye or similar sensor is installed near the mainline conveyor to indicate the presence of a pallet load, while a photoelectric eye or similar sensor is also installed near the crane interface station to indicate the presence of a pallet load.

The signals from the various sensors are input into a programmable logic controller. Based on the application of the control logic, output signals are generated and sent to a variable frequency drive, which controls the linear movement of the shuttle car along the track through operation of a motor mounted on the shuttle car.

### DESCRIPTION OF THE DRAWINGS

FIG. 1 is a perspective view of a pallet load transport system incorporating a control system in accordance with the present invention;

FIG. 2 is a side view of the pallet load transport system of FIG. 1, illustrating the shuttle car in a home or queue position;

FIG. 3 is a side view of the pallet load transport system of FIG. 1, illustrating the shuttle car at the mainline conveyor for pickup (or deposit) of a pallet load;

FIG. 4 is a side view of the pallet load transport system of FIG. 1, illustrating the shuttle car at the crane interface station for deposit (or pickup) of a pallet load; and

FIG. 5 is a schematic illustration of the control system of the pallet load transport system of FIGS. 1-4.

### DETAILED DESCRIPTION OF THE INVENTION

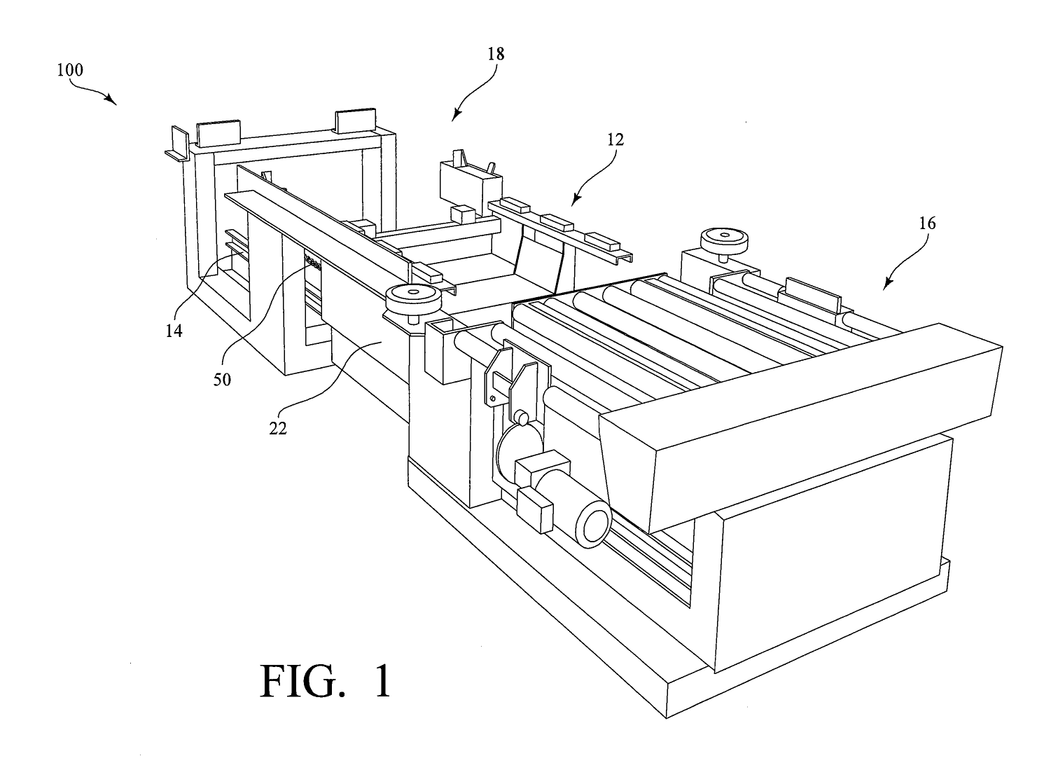

The present invention is a control system for a pallet load transport system. Referring first to FIG. 1, it should be recognized that a pallet load transport system 100 incorporating the control system 10 of the present invention operates in a similar manner as the prior art constructions discussed above. As such, the pallet load transport system 100 includes a shuttle car 12 that is supported by and moves along a track 14 between a mainline conveyor 16 and a crane interface station 18. The shuttle car 12 is generally comprised of a lower carriage 20 and an upper carriage 22, and the upper carriage 22 is adapted for movement between a raised position and a lowered position relative to the lower carriage 20. In this regard, it is contemplated and preferred that the movement of the upper carriage 22 relative to the lower carriage 20 is achieved by providing wedges (not shown) on the upper carriage 22 that face downward toward the lower carriage 20. Corresponding cam rollers (not shown) are mounted to the lower carriage 20, with such cam rollers engaging and riding along the surfaces of the wedges on the upper carriage 22. Thus, as the shuttle car 12 moves along the track 14, by mechanically and temporarily restricting linear movement of the upper carriage 22, for example, as the shuttle car 12 approaches the mainline conveyor 16, the upper carriage 22 may be lowered (or raised) with respect to the lower carriage 20, with the cam rollers of the lower carriage 20 riding along the wedges of the upper carriage 22. As such, no separate hydraulic or pneumatic system for movement of the upper carriage 22 between a raised position and a lowered position relative to the lower carriage 20 is required.

As the shuttle car 12 carries a pallet load (not shown) between a pick-up location and a deposit location, the upper carriage 22 is commonly in a raised position relative to the lower carriage 20, but as the shuttle car 12 approaches the mainline conveyor 16 or the crane interface station 18, it is in a lowered position to pick-up or in a raised position to deposit a pallet load. For inbound transport, the shuttle car 12 will pick-up a pallet load from the mainline conveyor 16 and deposit it at the crane interface station 18. For outbound transport, the shuttle car 12 will pick-up a pallet load from the crane interface station 18 and deposit it at the mainline conveyor 16.

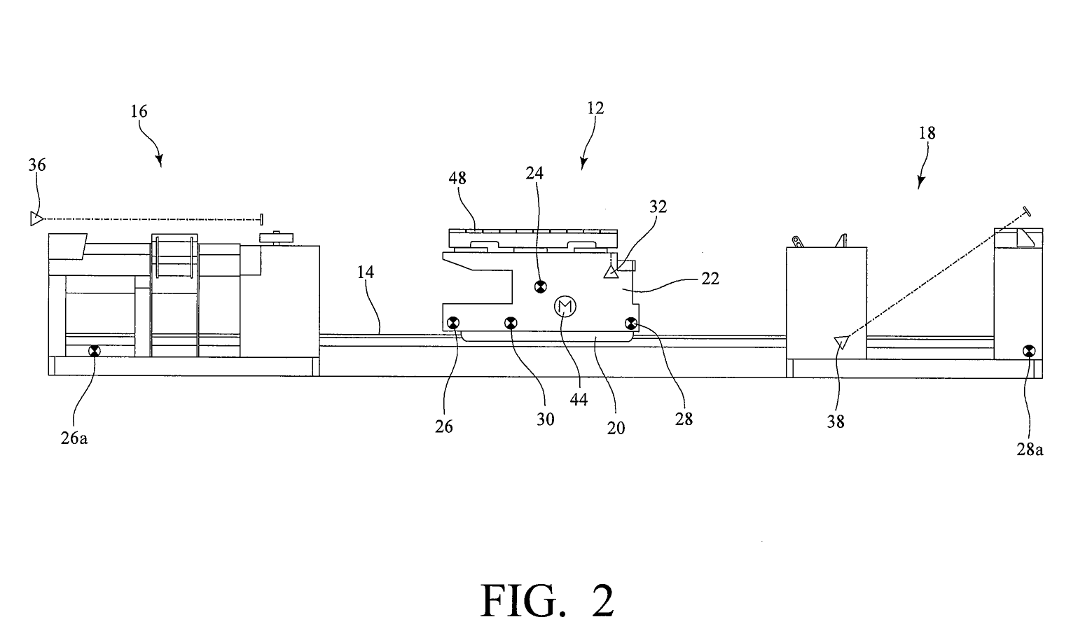

Referring now to FIGS. 2-5, the control system 10 of the present invention monitors and controls all operation of the shuttle car 12, ensuring proper and safe transfer of pallet loads from a pick-up location to a deposit location. Specifically, in this exemplary embodiment, an encoder or similar measuring device (PT1) 24 is installed on the shuttle car 12 and is used to determine the linear position of the shuttle car 12 along the track 14. Additionally, proximity or limit switches (PX3) 26 and (PX4) 28 are installed on the shuttle car 12 with corresponding targets 26a, 28a near the mainline conveyor 16 and the crane interface station 18 in order to detect any over travel of the shuttle car 12. With respect to the raising and lowering of the shuttle car 12, a proximity or limit switch (PX1) 30 is also installed on the shuttle car 12 and is used to determine whether the upper carriage 22 is in the raised or lowered position with respect to the lower carriage 20. To determine the presence of a pallet load 48 on the shuttle car 12, one or more photoelectric eyes (PE1) 32 or similar sensors are also installed on the shuttle car 12. Finally, a photoelectric eye or similar sensor (PE2) 36 is installed near the mainline conveyor 16 to indicate that a pallet load is present, while a photoelectric eye or similar sensor (PE3) 38 is also installed near the crane interface station 18 to indicate that a pallet load is present.

Encoders, proximity or limit switches, and photoelectric eyes are all types of measuring devices and/or sensors that are well-known and understood by one of ordinary skill in the art. For purposes of example only, Table A identifies commercially available measuring devices and sensors that may be used in accordance with the teachings of the present invention:

TABLE A

| Sensor | Model Number | Manufacturer |
|---|---|---|
| (PT1) | XS608B1PAL | Schneider Electric Industries SAS |
| | | Rueil-Malmaison, France |
| (PX3) | XS618B1PAMI2 | Schneider Electric Industries SAS |
| | | Rueil-Malmaison, France |
| (PX4) | XS618B1PAMI2 | Schneider Electric Industries SAS |
| | | Rueil-Malmaison, France |
| (PX1) | XS618B1PAMI2 | Schneider Electric Industries SAS |
| | | Rueil-Malmaison, France |
| (PE1) | XUBOBPSNM12 | Schneider Electric Industries SAS |
| | | Rueil-Malmaison, France |
| (PE2) | XUBOBPSNM12 | Schneider Electric Industries SAS |
| | | Rueil-Malmaison, France |
| (PE3) | XUBOBPSNM12 | Schneider Electric Industries SAS |
| | | Rueil-Malmaison, France |

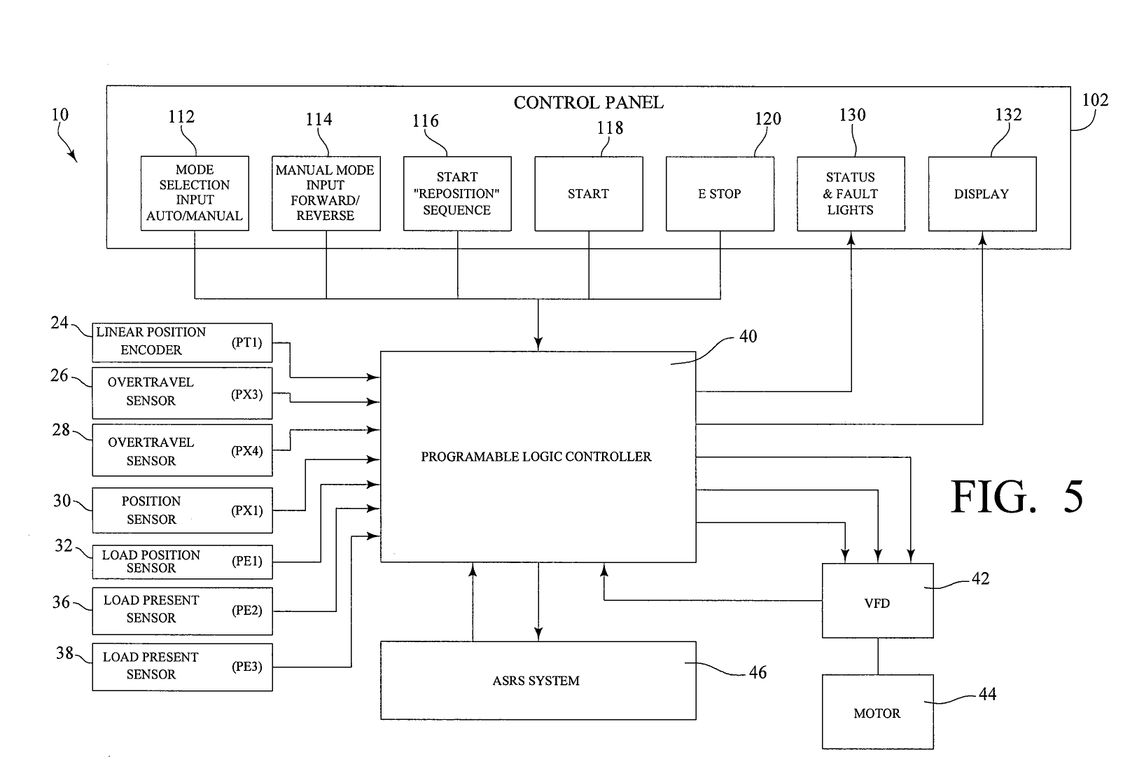

As best illustrated in FIG. 5, the signal from each of the various sensors is inputted into a programmable logic controller 40. Additionally, it is contemplated that additional input signals would be received from an existing automatic storage and retrieval system (ASRS) control system 46 to verify safe conditions for picking up or depositing. Based on the application of the control logic, output signals are generated and sent to a variable frequency drive (VFD) 42 mounted on the shuttle car 12, which controls the linear movement of the shuttle car 12 along the track 14 through operation of a motor 44 also mounted on the shuttle car 12, as further described below.

In this exemplary embodiment, and as illustrated in FIG. 1, a chain 50 extends along the length of the track 14. With the motor 44 mounted on the shuttle car 12, only a single length of chain is required, reducing by half the amount of chain as compared to prior art constructions in which the drive/motor was located at one end of the track, i.e., near the mainline conveyor or the crane interface station. Furthermore, by using a variable frequency drive 42, as opposed to the two-speed drive of prior art constructions, smooth operation and travel of the shuttle car 12 along the track 14 is ensured. In this regard, one preferred drive 42 for use in accordance with the present invention is Model No. ATV31HU15N3 manufactured and distributed by Schneider Electric Industries SAS of Rueil-Malmaison, France, and one preferred motor 44 for use in accordance with the present invention is Model No. SK 92372 AX-90 S/L manufactured and distributed by Getriebebau Nord GmbH & Co. (d/b/a Nord Gear) of Bargteheide, Germany. Other course, various other drives and/or motors could be readily incorporated into the pallet load transport system described herein without departing from the spirit and scope of the present invention.

Furthermore, and as also illustrated in FIG. 5, it is contemplated that the programmable logic controller 40 allows not only for automated operation (based on the application of the control logic), but also for manual operation. In a manual mode, the programmable logic controller 40 would disregard the input signals and allow an individual operator to manually control the shuttle car 12. For example, to allow for such manual operation, in the exemplary embodiment, a control panel 110 associated with the control system 10 includes a selector switch or similar input device 112 that allows a user to select between automated or manual operation. If manual operation is selected, another selector switch or similar input device 114 allows the user to advance the shuttle car 12 forward or in reverse by sending an appropriate signal through the programmable logic controller 40 to the VFD 42 that operates the motor 44. Such manual operation might be necessary for set-up, maintenance, or repositioning of the shuttle car 12 after a safety fault.

Furthermore, in this exemplary embodiment and referring still to FIG. 5, the control panel 102 further includes: a selector switch or similar input device 116 for initiating a repositioning sequence (as further described below); a selector switch or similar input device 118 for a restart after a safety fault has been indicated and corrected or after switching from manual to automatic mode; and a selector switch or similar input device 120 for manually stopping the shuttle car during an emergency.

Finally, in this exemplary embodiment and referring still to FIG. 5, the control panel 102 further includes certain visual indicators 130 that provide notification of the status of the pallet load transport system 100 and/or warnings as to fault conditions. Similarly, the control panel 102 in this exemplary embodiment includes a display screen 132, which can be used to provide various information about the status of the pallet load transport system 100 and/or warnings as to fault conditions.

Referring now to FIG. 2, with respect to movement of the shuttle car 12 along the track 14, in this exemplary embodiment, the shuttle car 12 is positioned in a home position (Position 1) or a queue position (Position 3) waiting to pick-up the pallet load 48 at Position 2 and deliver that pallet load 48 to Position 4. For inbound transport, the shuttle car 12 will pick-up a pallet load from the mainline conveyor 16 and deposit it at the crane interface station 18. For outbound transport, the shuttle car 12 will pick-up a pallet load from the crane interface station 18 and deposit at the mainline conveyor 16. The following table lists the programmable logic controller input definitions for each of these positions:

TABLE B

| | |
|---|---|
| Position 1 (Home) | (PE1) indicates no pallet load on shuttle car. |
| | (PT1) indicates shuttle car is at Position 1. |
| | (PX1) indicates upper carriage is in lowered |
| | position relative to lower carriage. |
| Position 2 (Pick-up) | (PE1) indicates pallet load on shuttle car. |
| | (PT1) indicates shuttle car is at Position 2. |
| | (PX1) indicates upper carriage is in raised |
| | position relative to lower carriage. |
| Position 3 (Queue) | (PE1) indicates pallet load on shuttle car. |
| | (PT1) indicates shuttle car is at Position 3. |
| | (PX1) indicates upper carriage is in raised |
| | position relative to lower carriage. |
| Position 4 (Delivery) | (PE1) indicates no pallet load on shuttle car. |
| | (PT1) indicates shuttle car is at Position 4. |
| | (PX1) indicates upper carriage is in lowered |
| | position relative to lower carriage. |

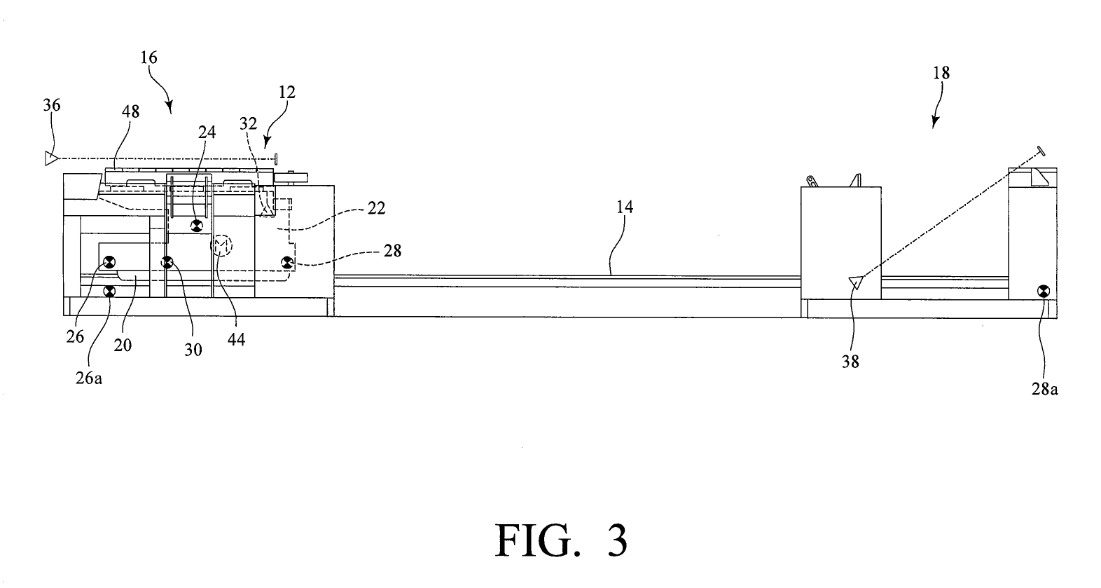

In operation, when the existing ASRS control system 46 in a facility places the pallet load 48 at Position 2, as illustrated in FIG. 3 at the mainline conveyor 16, it sends a signal to the programmable logic controller 40 indicating such placement has taken place. When (PE2) 36 detects that the pallet load 48 is present, the programmable logic controller 40 will send a verification signal back to the ASRS control system 46. On the other hand, if the programmable logic controller 40 is in automatic mode and indicates that the shuttle car 12 is in Position 1, it sends a “forward on” signal to the VFD 42, along with a “normal” speed signal. When (PT1) 24 indicates that the shuttle car 12 is a predetermined distance from Position 2 (for example, twelve inches), the programmable logic controller 40 changes the speed signal to the VFD 42 and causes the shuttle car 12 to slow as it approaches Position 2 and to stop when it reaches Position 2.

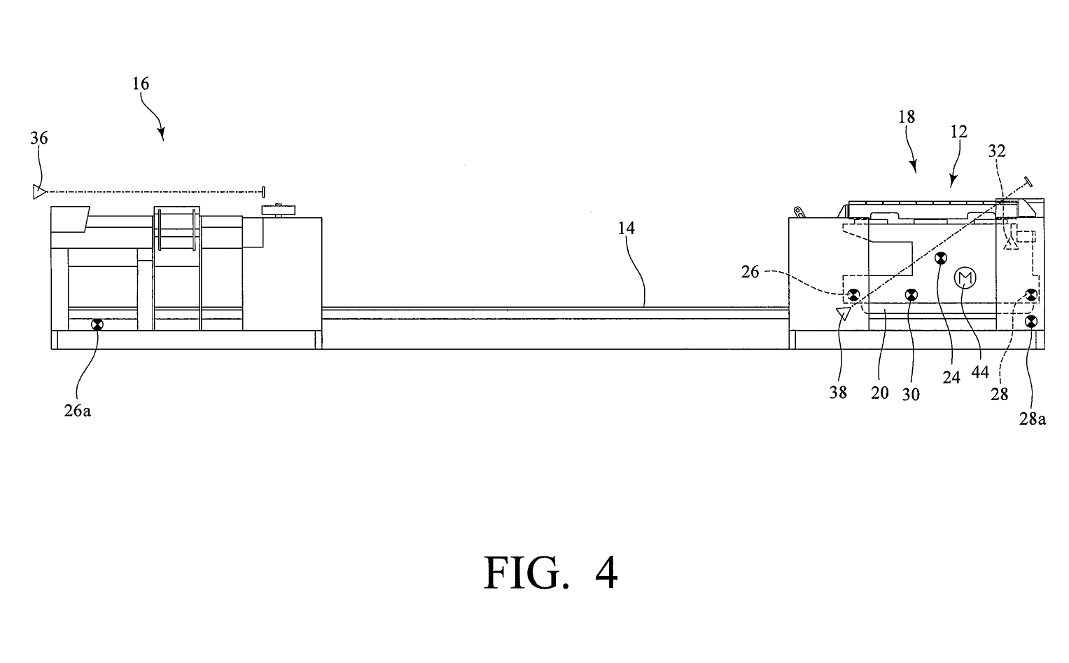

Once the shuttle car 12 is verified that it is at Position 2 with the pallet load 48 on the shuttle car 12, through the inputs set forth above in Table B, the programmable logic controller will cause the shuttle car 12 to move at normal speed in the opposite direction to Position 3. When (PE3) 38 indicates that the deposit location, as illustrated in FIG. 4 at the crane interface station 18, is clear, the programmable logic controller 40 causes the shuttle car 12 to move toward Position 4 at normal speed. When (PT1) 24 detects the shuttle car 12 is a predetermined distance from Position 4 (for example, twelve inches), the programmable logic controller 40 changes the speed signal to the VFD 42 and causes the shuttle car 12 to slow as it approaches Position 4. As it slows, the upper carriage 22 of the shuttle car 12 is lowered relative to the lower carriage 20, and the shuttle car 12 then stops at Position 4, as can be verified through the inputs set forth above in Table B. When the positioning of the shuttle car 12 at Position 4 is verified, the programmable logic controller 40 will send a “forward on” signal to the VFD 42 to return the shuttle car 12 to Position 1. When the shuttle car 12 arrives at Position 1, the programmable logic controller 40 will verify the pallet load 48 is present at the deposit location and will send a signal to the existing ASRS control system 46 indicating that the pallet load 48 is ready to be taken away by a crane (not shown).

As a further refinement, if either (PX3) 26 or (PX4) 28 indicates an over travel of the shuttle car 12, the programmable logic controller 40 will immediately send a signal to the VFD 42 that prevents further operation of the VFD 42 until the over travel condition is corrected. Finally, while the shuttle car 12 is moving from one position to another, if any of (PX1) 30, (PE1) 32, (PE2) 36, and/or (PE3) 38 change conditions, the programmable logic controller 40 will immediately stop the shuttle car 12. For example, if the shuttle car 12 is moving from Position 2 to Position 3, and (PE1) 32 indicates that a pallet load is no longer present on the shuttle car 12, the programmable logic controller 40 will immediately stop the shuttle car 12.

Since the positioning of the shuttle car 12 along the track is relative, the programmable logic controller 40 relies on a zero reference; for example, the over travel location at the crane interface station 18 may serve as the zero reference. If there is a power outage, the programmable logic controller 40 loses its zero reference. The shuttle car 12 can then be “repositioned” by initiating a repositioning sequence, where the shuttle car 12 slowly moves to the over travel target 28a located at the crane interface station 18, which re-zeros the counter for the encoder (PT1) 24 incorporated into programmable logic controller 40 to zero. The repositioning sequencing can be initiated manually by using the selector switch or similar input device 116 on the control panel 102, or it may occur automatically if a power outage occurs during normal operation and sensor inputs and ASRS inputs indicate it is safe and appropriate to do so.

Any number of other fault inputs could also cause the programmable logic controller 40 to require repositioning of the shuttle car 12, including, but not limited to: VFD overload, emergency stop, a missing pallet load indication, a positioning encoder fault, a failure with respect to movement of the upper carriage of the shuttle car relative to the lower carriage, and pallet load over travel.

One of ordinary skill in the art will recognize that additional embodiments are also possible without departing from the teachings of the present invention. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A pallet load transport system for moving pallet loads from a pick-up location to a deposit location, comprising:
a track extending between said pick-up location and said deposit location;
a shuttle car adapted for movement along said track, including a lower carriage and an upper carriage, the upper carriage being adapted for movement between a raised position and a lowered position relative to the lower carriage;
a drive, which controls movement of the shuttle car along said track; and
a control system, including
at least one measuring device for determining a linear position of the shuttle car along the track, and
a programmable logic controller receiving a signal from said measuring device and sending signals to said drive to control movement of the shuttle car along said track based on the received signal.

2. The pallet load transport system as recited in claim 1, wherein the at least one measuring device for determining the linear position of the shuttle car along the track is installed on the shuttle car.

3. The pallet load transport system as recited in claim 1, wherein the at least one measuring device for determining the linear position of the shuttle car along the track is an encoder.

4. The pallet load transport system as recited in claim 1, wherein said control system further includes at least one sensor for determining if a pallet load is present on the shuttle car, said programmable logic controller also receiving a signal from this sensor, and then sending signals to said drive to control movement of the shuttle car along said track based on the received signals.

5. The pallet load transport system as recited in claim 4, wherein the at least one sensor for determining if the pallet load is present on the shuttle car is a photoelectric eye installed on the shuttle car.

6. The pallet load transport system as recited in claim 1, wherein said control system further includes at least one sensor for determining whether said upper carriage is in the raised or the lowered position, said programmable logic controller also receiving a signal from this sensor, and then sending signals to said drive to control movement of the shuttle car along said track based on the received signals.

7. The pallet load transport system as recited in claim 4, wherein said control system further includes at least one sensor for determining whether said upper carriage is in the raised or the lowered position, said programmable logic controller also receiving a signal from this sensor, and then sending signals to said drive to control movement of the shuttle car along said track based on the received signals.

8. The pallet load transport system as recited in claim 1, wherein said control system further includes at least one sensor installed on the shuttle car for detecting any over travel of the shuttle car at the pick-up location and/or deposit location, said programmable logic controller also receiving a signal from this sensor.

9. The pallet load transport system as recited in claim 1, wherein said control system further includes at least two proximity switches installed on the shuttle car with corresponding targets installed at either end of the track near the pick-up location and the deposit location for detecting any over travel of the shuttle car, said programmable logic controller also receiving a signal from each of these proximity switches.

10. The pallet load transport system as recited in claim 1, wherein said control system further includes a sensor installed near the pick-up location to indicate that a pallet load is present, said programmable logic controller also receiving a signal from this sensor.

11. The pallet load transport system as recited in claim 1, wherein said control system further includes a sensor installed near the deposit location to indicate that a pallet load is present, said programmable logic controller also receiving a signal from this sensor.

12. The pallet load transport system as recited in claim 1, wherein said control system further receives input signals from an existing automatic storage and retrieval system (ASRS) control system to verify safe conditions at the pick-up location and/or deposit location.

13. The pallet load transport system as recited in claim 1, wherein said drive includes a variable frequency drive and a motor.

14. The pallet load transport system as recited in claim 13, wherein said motor is mounted on the shuttle car.

15. The pallet load transport system as recited in claim 1, wherein said control system includes a control panel with one or more input devices that allow for manual operation of the shuttle car by a user.

16. The pallet load transport system as recited in claim 1, wherein said control system includes a control panel with one or more input devices for initiating a repositioning sequence to establish a zero reference identifying the linear position of the shuttle car along the track.

17. The pallet load transport system as recited in claim 1, wherein said control system includes a control panel with one or more visual indicators that provides notification of a status of the pallet load transport system and/or warnings as to fault conditions.

18. The pallet load transport system as recited in claim 1, wherein said control system includes a display screen that provides various information about a status of the pallet load transport system and/or fault conditions.

19. A control system for a pallet load transport system for moving pallet loads from a pick-up location to a deposit location through movement of a shuttle car along a track extending between said pick-up location and said deposit location, comprising:
at least one measuring device for determining a linear position of the shuttle car along the track;
at least one sensor for determining if a pallet load is present on the shuttle car;
at least one sensor for determining whether an upper carriage of the shuttle car is in a raised position or a lowered position relative to a lower carriage of the shuttle car; and
a programmable logic controller receiving signals from said measuring device and said sensors, and then sending signals to a drive to control linear movement of the shuttle car along said track based on the received signals.

20. The control system for a pallet load transport system as recited in claim 19, wherein said drive includes a variable frequency drive and a motor.

21. The control system for a pallet load transport system as recited in claim 20, wherein said motor is mounted on the shuttle car.

22. The control system for a pallet load transport system as recited in claim 19, and further comprising at least one sensor installed on the shuttle car for detecting any over travel of the shuttle car at the pick-up location and/or deposit location, said programmable logic controller also receiving a signal from this sensor.

23. The control system for a pallet load transport system as recited in claim 19, and further comprising at least two proximity switches installed on the shuttle car with corresponding targets installed at either end of the track near the pick-up location and the deposit location for detecting any over travel of the shuttle car, said programmable logic controller also receiving a signal from each of these proximity switches.

24. The control system for a pallet load transport system as recited in claim 19, and further comprising a sensor installed near the pick-up location to indicate that a pallet load is present, said programmable logic controller also receiving a signal from this sensor.

25. The control system for a pallet load transport system as recited in claim 19, and further comprising a sensor installed near the deposit location to indicate that a pallet load is present, said programmable logic controller also receiving a signal from this sensor.

26. The control system for a pallet load transport system as recited in claim 19, wherein said control system further receives input signals from an existing automatic storage and retrieval system (ASRS) control system to verify safe conditions at the pick-up location and/or deposit location.

27. The control system for a pallet load transport system as recited in claim 19, and further comprising a control panel with one or more input devices that allow for manual operation of the shuttle car by a user.

28. The control system for a pallet load transport system as recited in claim 19, and further comprising a control panel with one or more input devices for initiating a repositioning sequence to establish a zero reference identifying the linear position of the shuttle car along the track.

29. The control system for a pallet load transport system as recited in claim 19, and further comprising a control panel with one or more visual indicators that provides notification of a status of the pallet load transport system and/or warnings as to fault conditions.

30. The control system for a pallet load transport system as recited in claim 19, and further comprising a display screen that provides various information about a status of the pallet load transport system and/or fault conditions.
